(19) United States
(12) Patent Application Publication
(10) Pub. No.: US 2008/0167817 A1
(43) Pub. Date: Jul. 10, 2008

(54) AUTOMATED CARGO LOADING SYSTEMS AND METHODS

(75) Inventors: Tommy Axel Hessler, Charlotte, NC (US); Lennart K.F. Johansson, Charlotte, NC (US)

Correspondence Address: ADAMS INTELLECTUAL PROPERTY LAW, P.A., Suite 2350 Charlotte Plaza, 201 South College Street, CHARLOTTE, NC, 28244, US

(73) Assignee: TRANSBOTICS CORPORATION, Charlotte, NC (US)

(21) Appl. No.: 11/961,321

(22) Filed: Dec. 20, 2007

Related U.S. Application Data
(60) Provisional application No. 60/883,776, filed on Jan. 6, 2007.

(51) Int. Cl. G01C 21/00

(52) U.S. Cl. 701/223

(57) ABSTRACT

A cargo loading system comprising a control module for coordinating the transportation of cargo from one area to a trailer according to a stacking pattern and delivery route, an AGV control module for controlling the operation and navigation of at least one AGV, and a user interface for inputting commands and receiving outputs into/from the system. A method for loading cargo comprising the steps of providing a cargo loading control module, providing an AGV control module in communication with the cargo loading control module, providing a user interface, communicating cargo loading tasks to an AGV, and transporting cargo from a production area to a trailer in accordance with a stacking pattern and along a dynamic guide path.

### CROSS-REFERENCE TO RELATED APPLICATIONS

The present application claims priority to U.S. Provisional Patent Application No. 60/883,776 filed Jan. 6, 2007 and entitled “Method and Apparatus for Automatically Loading Cargo.”

### TECHNICAL FIELD AND BACKGROUND OF THE INVENTION

The present invention relates generally to systems and methods for automating cargo loading such as truck loading, and more specifically, to systems and methods for cargo loading that include creating automated vehicle dynamic guide paths, generating stacking patterns based on a delivery route and controlling an automatic guided vehicle system for loading cargo in accordance with the stacking pattern.

Current cargo loading practices are very labor intensive, particularly in circumstances in which a large number of orders are required to be delivered to a number of different customer on the same transport trailer. Customer orders are typically filled by gathering together pre-selected products from a group of source products, and stacking and packaging the products to create a cohesive unit for loading and shipping. It is common to package products on a pallet, referred to herein as “palletizing,” wherein the pallet serves as a platform for supporting the products. A pallet typically includes one or more clearances there through for receiving forklift skids or a lifting member of an automatic guided, so that the pallet can be transported. Once packaged, pallets are typically moved to a loading zone where they await loading onto a trailer or other transport for delivery by truck, rail, sea and/or air.

Conventional cargo loading practices typically include manually loading pallets onto a trailer by workers. Workers typically gather pallets according to a provided list, and load the pallets onto the trailer using a forklift or hand-truck. The stacking pattern of the pallets in the trailer is typically determined during loading by the workers based on the delivery schedule, and thus the success of the stacking process depends upon the ability of the workers to create and implement a proper stacking pattern that results in efficient unloading, especially when the delivery includes multiple orders and destinations. Further, because trailers are manually loaded, an automated system is not in place to ensure that all of the cargo is in fact loaded. Pallets that are not actually loaded and pallets that are loaded onto an incorrect trailer result in incomplete orders and missed deliveries that lead to delays, additional deliveries, increased costs and time, and customer dissatisfaction.

In this regard, what is desired are cargo loading systems and methods that eliminate or significantly reduce the need for worker manual labor to load cargo while improving order accuracy and providing the most efficient stacking pattern for unloading the trailer based upon a predetermined delivery route. Further, cargo loading systems and methods are desired that create stacking pattern instructions and implement those instructions using automated guided vehicles. Still further, what is desired are automated processes for loading cargo based upon an “unloaded first is loaded last” packing strategy to improve unloading efficiency.

### SUMMARY OF THE INVENTION

In various embodiments provided herein, the present invention provides systems and methods for automating truck loading of packaged cargo using system controlled Automatic Guided Vehicles (AGVs) based upon a created loading pattern generated from a cargo delivery route. The system preferably utilizes a LADAR (laser) system to detect a location of a trailer to be loaded and a guidance system to create dynamic automated vehicle loading guide paths to adapt to the physical location of the trailer within a loading dock without requiring physical modifications to the trailer or the loading dock.

In various embodiments provided herein, the present invention provides automated cargo loading systems and methods for truck loading facilities including loading bays. The systems include AGVs and both dynamically generated and predetermined vehicle guide paths for moving cargo between a pallet production area and the trailer. In preferred embodiments, the trailer or other container to be loaded is stationary within a loading bay and its position detected by and known by a navigation module of the system. Loading instructions are preferably generated in part from the known position of the trailer. Guided vehicles scan the interior of the stationary trailer to determine the trailer's location and reveal whether other cargo in the form of pallets is already present and loaded. The loading instructions are capable of accommodating the existence of previously loaded cargo. The guided vehicles are equipped with a suitable sensor system capable of scanning in three dimensions, such as a 3D “LADAR” scanner.

In one embodiment, the present invention provides an automated cargo loading system and method whereby pallets are loaded onto a trailer according to a selected stacking pattern based on the presence or absence of previously loaded cargo pallets, the distribution of the weight or the cargo to be loaded within the trailer, and a delivery route so that the trailer can be unloaded in sequence with the delivery route. The system includes a 3D LADAR sensor system, a laser guided navigational system, control modules and software applications for generating loading instructions and performing loading using one or more automatic guided vehicles. Packaged orders, for example in the form of pallets, are delivered to a predetermined loading area and loaded in accordance with the stacking pattern. Pallets and trailers include identification labels that are scanned and entered into the system. The identity of a pallet is verified prior to loading the pallet onto a trailer so that only “authorized” pallets are loaded for delivery. AGVs travel along predetermined or dynamically generated guide paths to transport the pallets from a production or storage area to the appropriate trailer. The automatic guided vehicles carry out assigned tasks and return to a home position for recharging as needed between uses. Pallet pick-up and delivery and overall system control is coordinated and monitored by a movement optimizer module. The system may further include an operator interface for communication with the optimizer module.

In another embodiment, the present invention provides a system of control modules for controlling automated cargo loading that provide real-time status, conditions and events of the system. The system includes an AGV system that includes at least one AGV that operates at the request and instruction of a movement optimizer module that delivers guide path instructions, provides pick-up and delivery destinations, initiates transportation tasks, and maintains a history of events and errors, among other conditions. AGVs suitable for use in the cargo loading systems of the present invention preferably include safety features, lifting devices, navigational components and pallet and trailer identification label scanning devices, among other components. The AGVs preferably include two complementary detection systems, one of which is a “SICK” laser bumper or other safety sensor, or a SICK or other navigation sensor. The safety sensor may also be used to detect the interior walls of the trailer and thus generates maneuvering instructions within the trailer for the system. Thus, there may be three different sensors in the automatic guided vehicles: 1) a rotating, mast-mounted laser used for navigation; 2) a stationary “safety” laser also used for navigation; and 3) a 3D sensor that detects existing cargo.

In yet another embodiment, the present invention provides automated cargo loading systems and methods that communicate with automated order fulfillment systems and methods that optimize the flow of materials to build pallets of products that match the requirements of customer orders.

Additional features and advantages of the invention will be set forth in the detailed description which follows, and in part will be readily apparent to those skilled in the art from that description or recognized by practicing the invention as described herein.

### BRIEF DESCRIPTION OF THE DRAWINGS

Various embodiments of the invention have been set forth above. Other embodiments and advantages of the invention will appear as the description of the invention proceeds when taken in conjunction with the following drawings, in which:

FIG. 1 is a system diagram illustrating the cargo loading system in accordance with an embodiment of the present invention;

FIG. 2 is an exemplary plan view of a facility for implementing the systems and methods of the present invention; and

FIGS. 3a-c are flowcharts illustrating a method for automating cargo loading in accordance with an embodiment of the present invention.

### DETAILED DESCRIPTION OF THE INVENTION

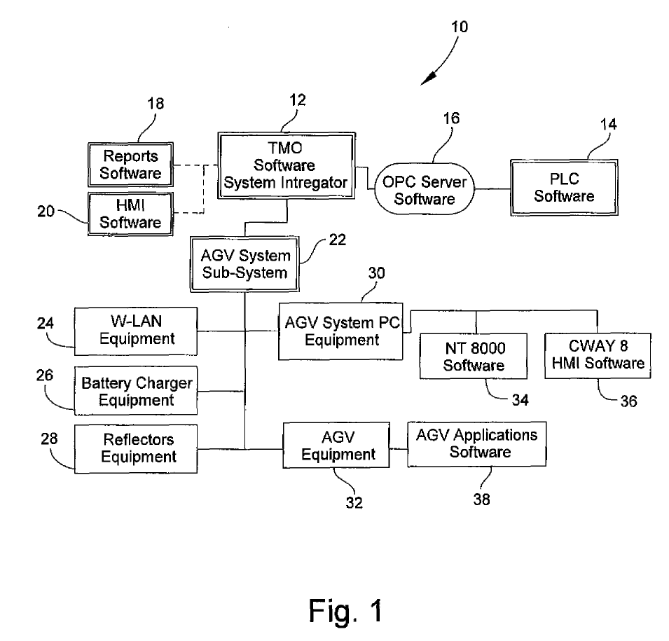

Referring now to the drawings, systems and methods for generating loading instructions and automating cargo loading are described herein and are illustrated in FIGS. 1-3c. While the systems and methods are described with reference to a particular embodiment in which trailers are loaded at loading bays, the systems and methods may be applied to any cargo loading environment in which cargo is moved from a loading area to a transport. In the exemplary embodiments provided herein, the loading instructions are generated based upon a predetermined delivery route, however, the instructions may be generated based upon other parameters such as delivery priority, weight, and pallet size. As used herein, the term “cargo” generically describes any item loaded onto a trailer, and preferably refers to a packaged pallet.

Referring to FIG. 1, a system diagram illustrating communication between cargo loading modules of the system is shown. Pallets, pre-loaded with a customer-specific selection of products and packaged, are loaded according to a generated or selected stacking pattern and in an order so that the trailer or other transport is unloaded in sequence with a delivery route. The system 10 includes various control modules that reside on computers or servers as software applications. A main control module, referred to herein as the “Transportation Movement Optimizer” (TMO) module 12, or “cargo loading control module”, includes a software application for organizing, maintaining, commanding and recording data of the automated cargo loading system. The TMO module 12 is the software system integrator. The TMO module 12 communicates with a customer's Programmable Logic Controller (PLC) 14 via a server 16. Once the operator has selected the trailer and pattern, the TMO module 12 coordinates the pick-up and delivery of pallets to the designated bay, and validates and maintains the data for each of the bays. Optionally, the TMO module 12 builds and displays reports through a reports module 18 based on desired data, such as throughput numbers, error data and additional real time data. The TMO module 12 also optionally communicates with a user interface module 20 (HMI) for input/output of the system. The user interface module 20 allows users to manipulate the system and allows the system to produce the effects of the users' manipulation. Input/output may be in the form of graphical, textual and auditory information and control sequences.

The TMO module 12 farther communicates with an AGV sub-system module 22. The AGV module 22 communicates over a wired or wireless local area network (W-LAN) 24 with a plurality of AGV related control modules including: recharging equipment 26 for battery recharging; reflector or guidance equipment 28 for navigation of the AGVs; an AGV system PC 30 operable for input/output into the AGV sub-system; and AGV equipment 32 including one or more AGVs. The AGV system PC 32 includes operating navigational software 34 with environment related information and user interface software 36 for input/output into the AGV system. The AGV equipment 32 includes AGV software applications 38 for control. Communication may be established through tags that have logical names that are pointers to a designated memory address.

The AGV system controller preferably includes one or more software packages that reside on the PC. One application works in conjunction with the TMO module for AGV movement based on the signals and status of signals that are interfaced to the AGV system, such as the allocation of the AGV, route, route blocking, vehicle movement, order management, and communicating to the AGV. This application interfaces and interacts with the second application for providing for pictorial representation of the AGV system, error logging and system status. The second application is a Graphical User Interface (GUI) that runs on the AGV system controller and provides real time status and condition of the AGV, displays the AGV guide path, pick-up and delivery stations, and 10 statuses. This software application also provides the user with the ability to start orders manually, and maintains a history of events and errors in recursive event logs.

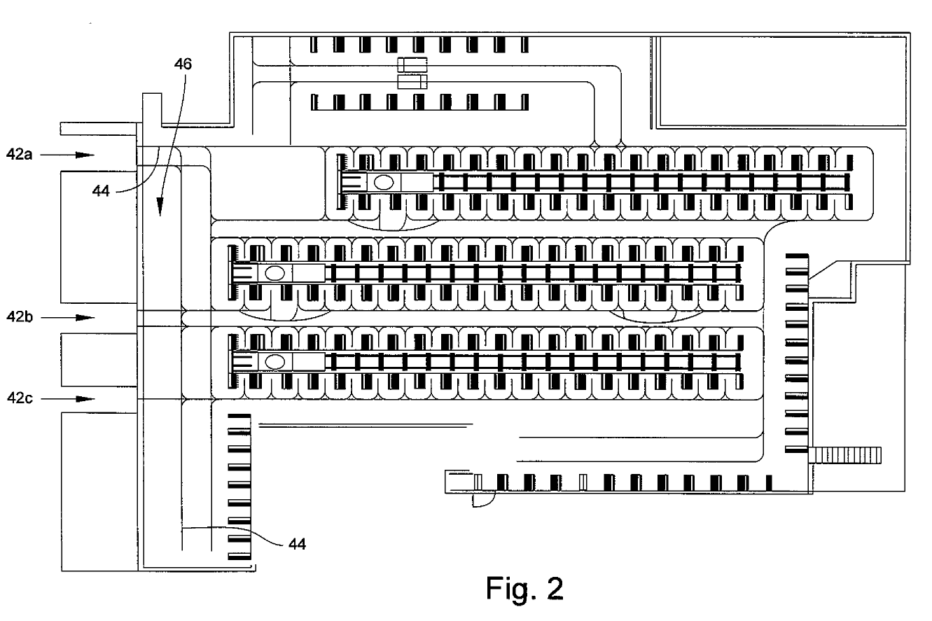

Referring to FIG. 2, an exemplary environment for practicing the systems and methods of the present invention is shown. The loading zone includes three loading bays, for example loading bay 9 shown at 42a, bay 10 42b and bay 11 42c, at which trailers (not shown) are parked for loading. AGVs travel along guide paths 44 between the bays and pallet pick-up zones 46. Pallet pick-up zones may be production areas, storage areas, conveyors and packaging areas. The guide paths for the AGVs address AGV traffic issues. Each bay includes guide paths onto a trailer for stacking the cargo according to the instructions. Pallets are preferably scanned for identification and authorization before entering a trailer. While any type of pallet or other container may be used, conventional “one-way” single-use wood pallets or “CHEP” are suitable.

The TMO module 12 is operable for controlling the system responsible for picking-up loaded pallets of secure, packaged product from a production line or storage area and automatically delivering the cargo to a predetermined assigned trailer occupying bay 9 42a, 10 42b or 11 42c in accordance with a stacking pattern. The system is adaptable for use with any type and size of trailer. The system may be pre-loaded with stacking patterns based on trailer identification, size and shape. By way of example, multiple stacking patterns may be allotted for each trailer. The selection of a stacking pattern is the initiation of an “order.” Stacking patterns may also be generated in real-time based on the delivery route and updated as the delivery route changes.

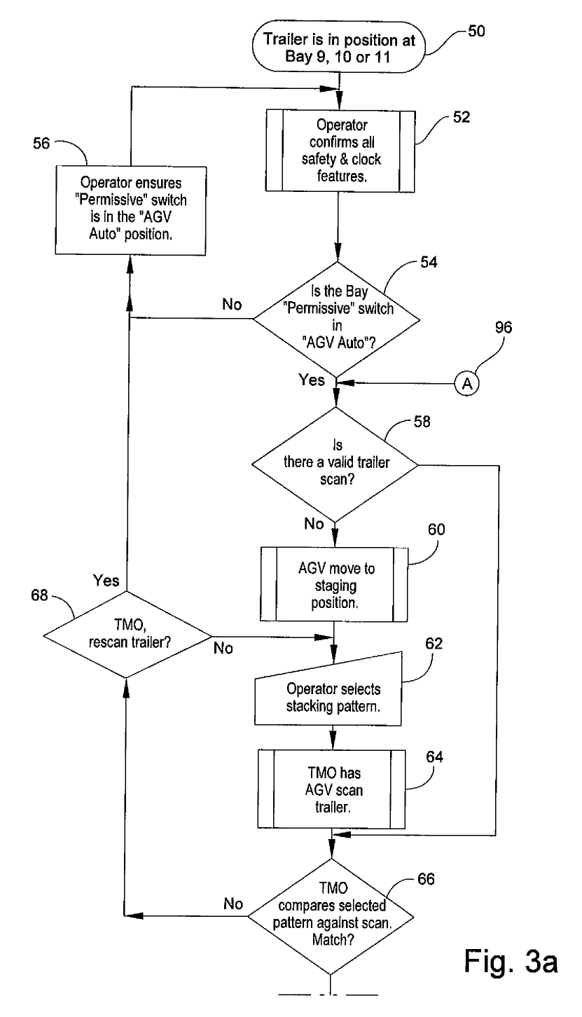

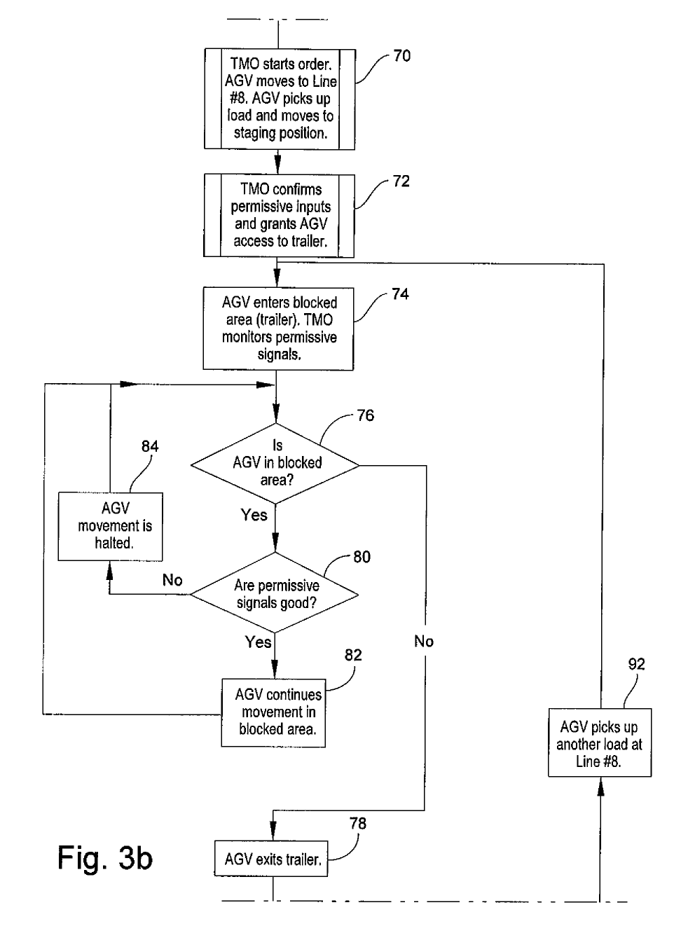

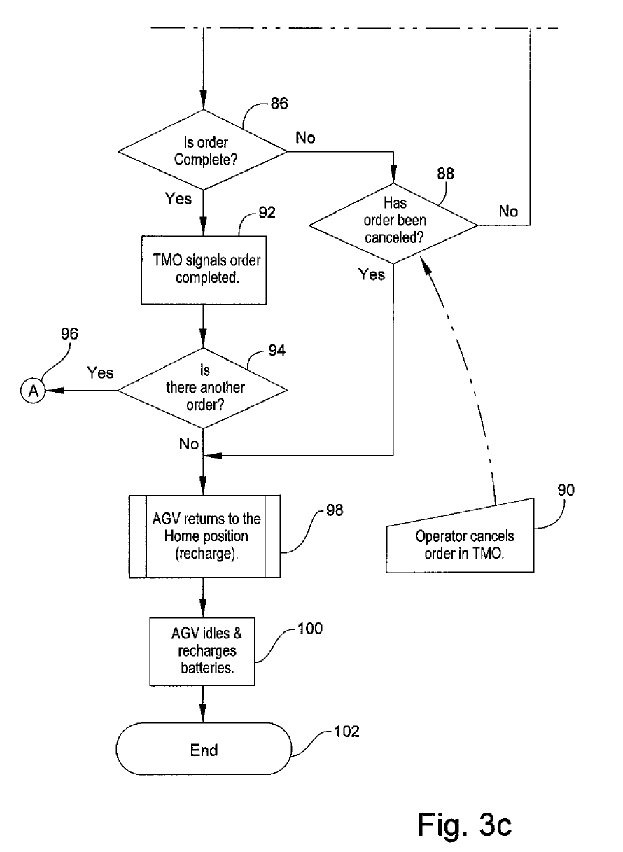

Referring specifically to FIG. 3a, the automated cargo loading process begins once a trailer is positioned in a designated bay (block 50), such as bay 9, 10 or 11 as shown in FIG. 2. The operator ensures safety and dock features are satisfied (block 52), such as that the appropriate dock is occupied properly, that both the trailer and bay door are open, and that any inhibit switches are in the “AGV automatic” position (block 54). If the bay permissive switch is not in the “AGV auto” position, the system and operator ensures that the permissive switch is put into the auto position (block 56). The operator then once again confirms all safety and dock features (block 52). Once the bay permissive switch is in the auto position, the system scans the trailer identification and determines if there is a valid trailer scan (block 58). Trailer scans are accomplished by an AGV, such as one available from Transbotics Corporation of Charlotte, N.C., moving to a staging position in front of the trailer door (block 60). Once the operator selects a stacking pattern (block 62) the AGV scans the trailer and reports to the TMO module 12 (block 64). The system validates the order by comparing the operator's selected stacking pattern against data from the scanned trailer (block 66). If a trailer scan is not valid, the TMO module 12 requests a trailer re-scan (block 68) once a new trailer is moved into position and the safety and dock requirements are satisfied.

Referring to FIG. 3b, the automated cargo loading process continues with the TMO module 12 initiating the order and sending an AGV to a production line or other pick-up area (block 70). The AGV follows guide paths to the appropriate pallet, picks-up the pallet, and returns it along guide paths to the appropriate trailer. Once at the trailer, the AGV scans the trailer and reports to the TMO module 12. The TMO module confirms permissive inputs and grants the AGV access to the trailer (block 72). Once access is granted, the AGV moves into the trailer and delivers the pallets to a designated location according to the pre-selected stacking pattern. The TMO module 12 monitors permissive signals (block 74). Throughout the loading process, the TMO module monitors blocks along the vehicle guide paths (block 76). If the AGV is not in a blocked area in the trailer, the AGV exits the trailer (block 78). If the AGV is in a blocked area, the AGV repeatedly sends area signals to the TMO module for interpretation (block 80). Once the signals are determined “good” or “not blocked,” the AGV continues movement (block 82). The AGVs continually send guide path information during movement. If the permissive signals are “bad” or “blocked,” AGV movement is halted and signals are sent again to the TMO module (block 84). Movement resumes after the obstruction is removed.

Referring to FIG. 3c, the automated cargo loading process continues with the TMO module 12 verifying if the order is complete after each delivery to the trailer (block 86). If the order is determined incomplete after a delivery by an AGV, the TMO module checks the order for the next pallet to be loaded, and if that pallet is still scheduled to be loaded or has been cancelled (block 88). After a delivery order has been entered but not yet filled, an operator has the option of canceling all or a portion of the order in the TMO module (block 90). If the order has not been cancelled, then the AGV is sent to pick up the order and loads it according to the process detailed above (block 92). If the order has been cancelled, loading continues with the next order. Once the order is determined complete, the TMO module signals that the order is complete (block 92). The TMO module then determines if another order is to be placed on the delivery trailer (block 94). If another order is to be loaded, the loading process repeats starting with a valid trailer scan and continues as detailed above (block 96). AGVs travel between the production line and the trailer until the validated stacking pattern is complete. Once the pattern is completed the order is complete. Once an order is complete, the A&V returns to a home base (block 98) where the AGV remains idle, recharges and waits for the next order (block 100). The automated cargo loading process ends (block 102) and begins again upon demand.

Stacking order is determined by the delivery route and is preferably based on a “what is loaded first is unloaded last” principle to improve unloading efficiency. The delivery route is determined by customer locations, delivery priority and product life-span. A customer order, including customer information, may be received through a customer information control system (CICS) transaction sever operable for transmitting customer orders. The orders may be received and processed by the supplier by a transaction interface module within a supplier's main server. Customer orders are transmitted on demand and are received and prioritized based on delivery date, delivery distance and sales branch, among other factors. The main server includes a database management transaction-SQL module (MS SQL) for database support and may include a pallet building module for optimizing the flow of materials required to build pallets of mixed products. The TMO module 12 may also be located on the main server. The pallet building module may also perform scheduling functions, inventory tracking, to/from moves, and provide a network and AGV interface.

An AGV used herein may be any type suitable for the requirements of a particular application. One suitable AGV is a forklift style having a three-wheel configuration (one steer and two drive) and quad functionality. The AGV functions by picking-up one pallet at a time from an inventory of pallets or from a conveyor, transporting the pallet to the correct trailer, entering the trailer, and placing the pallet on the floor or on top of another pallet as instructed. The vehicles may be equipped with a laser scanning bumper in the front of the vehicle, flashing lights, battery disconnects and emergency stop buttons. The front bumper may include a laser type S3000 mounted within a protective enclosure. Two detection areas are programmed in the S3000 logic to provide a long distance slow-down range and a short distance emergency-stop (e-stop) range. If the short distance c-stop range is broken, the vehicle enters an e-stop condition. Emergency stop buttons are located on each corner of the vehicle. The buttons must be manually reset before the vehicle re-starts. Activation (depressing the button) causes the vehicle to stop abruptly. An additional reset button may also be activated in conjunction with the emergency stop button reset.

The AGV preferably uses two components for navigation. First, a navigational laser is positioned and resides on top of a mast mounted on the AGV. This laser has a rotating laser scanner head that triangulates its position with the aid of reflectors strategically placed throughout the area. The scanner transmits a laser beam and receives the reflected beam, from which it measures angles between the reflectors and calculates its actual position. This information is updated many times per second. The position information is transmitted by a communications link such as an RS-422 serial link to the AGV controller. The second navigational component is, for example, a SICK scanner mounted near the top of the mast that navigates the AGV into the trailer. Two safety rated laser scanners are provided on the AGV, one located in the front and the other in the rear. These lasers utilize multiple dynamic fields for triggering the vehicle to slow down or emergency stop. Object detection is accomplished by a scanning laser that gathers information from bar code labels or other identifying indicia applied to the pallets or packaging, and also evaluates the positions of trailers that are docked at one of the loading docks. Dynamic guide paths are created each time the AGV enters the trailer. The combination of SICK guidance, dynamic paths and vision together provide an intelligent way to adapt to the physical location of the trailer without requiring modification to the trailer or loading dock. The AGV is able to overcome differences (within ranges) in trailer alignment to the loading dock in three dimensions. Thus, there may be three different sensors in the automatic guided vehicles: 1) a rotating, mast-mounted laser used for navigation; 2) a stationary “safety” laser also used for navigation; and 3) a 3D sensor that detects existing cargo.

In preferred embodiments, the trailer or other container to be loaded is stationary within a loading bay and its position detected by and known by the navigation module of the system. Loading instructions are preferably generated in part from the known position of the trailer. The AGVs scan the interior of the stationary trailer to determine the trailer's location and reveal whether other cargo in the form of pallets is already present and loaded. The loading instructions are capable of accommodating the existence of previously loaded cargo.

As stated above, the systems and methods described herein may be used in conjunction with a pallet building module that includes pallet building preparation and system control modules including, but not limited to, a production control interface module, a pallet controller module, a website management system controller module, and a logistics controller module. These modules communicate through an internal communication system to pallet building and transportation modules including, but not limited to, the automatic guided vehicle system controller module, a robot system controller module, a fork lift system controller module, and a conveyor system controller module. Upon receipt of a customer order, the pallet building module processes the order, runs programmed pallet building logic, begins a source product replenishment process, and begins the pallet building process.

Orders may change from the time that they are received to the time that they are loaded. Changes may include product type, quantity, and desired delivery date, among other customer requests. Assigned delivery priority may also change during an order life cycle based upon the customer changes, source items in stock and delivery routes, among others. Updated orders are processed and re-prioritized and new delivery routes are generated.

While automated cargo loading systems and methods have been described above with reference to particular embodiments and examples, it is intended that various details of the invention may be changed without departing from the scope of the invention. Furthermore, the foregoing description of the preferred embodiment of the invention and best mode for practicing the invention are provided for the purpose of illustration only and not for the purpose of limitation.

What is claimed is:

1. A system for automating cargo loading, comprising:
a cargo loading control module for coordinating the transportation of cargo from a production area onto a trailer positioned within a loading bay along a dynamic guide path and according to a stacking pattern;
at least one automatic guided vehicle comprising a sensor system and a laser guided navigational system; and
an automatic guided vehicle control module in communication with the cargo loading control module and operable for controlling the operation and navigation of the at least one automatic guided vehicle.

2. The system according to claim 1, further comprising a LADAR system for detecting the location of the trailer within the loading bay and detecting cargo present in the trailer.

3. The system according to claim 1, wherein the sensor system scans in three dimensions.

4. The system according to claim 1, wherein the guide path is dynamic and is determined by the physical location of the trailer within the loading bay and cargo present in the trailer.

5. The system according to claim l, wherein the cargo loading control module is further operable for generating a stacking pattern, initiating an order, granting the at least one automatic guided vehicle access into the trailer, coordinating movement of the at least one automatic guided vehicle, and modifying the stacking pattern based on operator inputs.

6. The system according to claim 1, wherein the cargo comprises pallets.

7. The system according to claim 1, wherein the automatic guided vehicle control module includes a software application that communicates with the cargo loading control module to coordinate automatic guided vehicle movement based on signals and signal status interfaced to the automatic guided vehicle control module.

8. The system according to claim 1, wherein the automatic guided vehicle control module includes a graphical user interface that provides real-time status and conditions of the at least one automatic guided vehicle, and displays guide paths and pick-up and delivery stations.

9. A method for loading cargo, comprising:
providing at least one automatic guided vehicle comprising a sensor system and a laser guided navigational system;
providing a cargo loading control module for coordinating the transportation of cargo from a production area to a trailer positioned within a loading bay;
providing an automatic guided vehicle control module in communication with the cargo loading control module and operable for controlling the operation and navigation of the at least one automatic guided vehicle;
communicating transportation tasks to the at least one automatic guided vehicle; and
transporting the cargo from the production area to the trailer along a dynamic vehicle guide path.

10. The method according to claim 9, further comprising:
identifying the position of the trailer within the loading bay with a laser capable of scanning in three dimensions.

11. The method according to claim 9, further comprising:
identifying the existence and position of any previously loaded cargo in the trailer by way of a laser capable of scanning in three dimensions.

12. The method according to claim 9, wherein the dynamic guide path is determined by a vision system and the laser guided navigational system.

13. The method according to claim 9, further comprising:
generating a stacking pattern, initiating an order, granting the at least one automatic guided vehicle access into the trailer, coordinating movement of the at least one automatic guided vehicle, and modifying the stacking pattern based on operator inputs.

14. The method according to claim 9, further comprising:
providing a graphical user interface that provides real-time status and conditions of the at least one automatic guided vehicle, and displays guide paths and pick-up and delivery stations.

15. A method for loading cargo, comprising:
positioning a trailer at a cargo loading bay;
identifying the trailer;
identifying the existence and position of any previously loaded cargo in the trailer with a sensor capable of scanning in three dimensions;
selecting a stacking pattern by which the cargo is stacked in the trailer;
initiating a loading order;
instructing an automatic guided vehicle to pick-up the cargo from a production area and deliver it to the trailer; and
stacking the cargo in accordance with the stacking pattern.

16. The method according to claim 15, further comprising:
granting the automatic guided vehicle access to the trailer;
monitoring guide paths that the automatic guided vehicle follows;
controlling the movement of the automatic guided vehicle; and
returning the automatic guided vehicle to base for recharging between uses.

17. The method according to claim 16, wherein identifying the trailer, selecting the stacking pattern by which the cargo is stacked in the trailer, initiating the loading order, instructing the automatic guided vehicle to pick-up the cargo from the production area and deliver it to the trailer, granting the automatic guided vehicle access to the trailer, monitoring guide paths that the automatic guided vehicle follows, controlling the movement of the automatic guided vehicle, and returning the automatic guided vehicle to the home base for recharging between uses are all controlled by a cargo loading control module.

18. The method according to claim 15, further comprising:
inputting operator commands to manipulate the method.

19. The method according to claim 15, further comprising:
comparing the selected stacking pattern against the trailer identification.

20. The method according to claim 15, further comprising:
satisfying safety and loading bay features prior to loading the trailer.
